(19) United States
(12) Patent Application Publication
(10) Pub. No.: US 2005/0185757 A1
(43) Pub. Date: Aug. 25, 2005

(54) Apparatus and method for nonintrusively inspecting an object

(76) Inventors: David E. Kresse, Walnut Creek, CA (US); Francois R. Gaultier, Oakland, CA (US)

Correspondence Address: Stephen M. De Klerk;BLAKELY, SOKOLOFF, TAYLOR & ZAFMAN LLP, Seventh Floor, 12400 Willshire Boulevard, Los Angeles, CA, 90025, US

(21) Appl. No.: 10/853,402

(22) Filed: May 24, 2004

Related U.S. Application Data
(60) Provisional application No. 60/546,554, filed on Feb. 20, 2004.

(51) Int. Cl. G01N 23/04

(52) U.S. Cl. 378/57

(57) ABSTRACT

An apparatus is disclosed for nonintrusively inspecting an object. The apparatus has a curtain assembly for attenuating scattered x-rays leaving the apparatus. The curtain assembly has a flexible member that forms a closed loop over the first and second horizontally spaced curtain rollers, and a plurality of radiation-resistant curtain members secured to the flexible member. Rotation of the curtain rollers causes movement of the curtain members in an orbital path. The curtain members are folded onto one another when moving in one direction at the top, and are suspended and hang down when they are at the bottom of the orbital path. The apparatus also has a conveyor belt on which objects can be located. The curtain members move at the same speed together with the conveyor belt and the objects located thereon. An advantage of the curtain assembly is that small objects can pass through the curtain assembly without being hindered by the weight of the curtains.

### CROSS-REFERENCE TO RELATED APPLICATIONS

Priority is claimed from U.S. Provisional Patent Application No. 60/546,554, filed on Feb. 20, 2004.

### BACKGROUND OF THE INVENTION

1). Field of the Invention

This invention relates to an apparatus and method for nonintrusively inspecting an object.

2). Discussion of Related Art

Nonintrusive inspection apparatus are commonly used for nonintrusively inspecting luggage or other closed containers before being loaded into a loading bay of an aircraft. Older generation inspection apparatus relied merely on conventional x-ray technology for nonintrusively inspecting closed containers. More recently, inspection apparatus which rely on computed tomography (CT) scanning technology have also been utilized.

An apparatus that utilizes CT scanning technology typically has a frame and a CT scanner subsystem rotatably mounted to the frame. The CT scanner subsystem has a gantry with a gantry opening through which an object, such as luggage, can pass. An x-ray source is mounted to the gantry and radiates x-rays through the object. X-ray detectors are mounted to the gantry on an opposing side of the opening to detect the x-rays after passing through the object. The x-ray source and detectors revolve together with the gantry about the object. A three-dimensional image of the contents of the object can be obtained by revolving the gantry and progressing the object through the x-rays.

An airport x-ray-based nonintrusive inspection apparatus usually has a conveyor belt on which the object is transported through the x-rays. Such an apparatus also has x-ray shielding forming a tunnel around the conveyor belt. A stationary curtain member usually hangs over an entrance or an exit of the tunnel and is made of a material that attenuates x-ray radiation to prevent x-rays from leaving in a direction parallel to the conveyor belt out of the apparatus. Objects transported on the conveyor belt push the curtain member out of the way to enter the apparatus, whereafter the curtain member again closes behind the object. Such a curtain member usually includes lead and, depending on the width of the conveyor belt, may be relatively large. Small, lightweight objects may not be able to move a large, heavy curtain out of the way.

Recently, x-ray based nonintrusive inspection apparatus have been fitted with “active curtains.” An active curtain is rolled up and down with a motor, alternately allowing for an object to pass and preventing x-rays from leaving the apparatus. One will appreciate that the provision of active curtains is expensive. Moreover, such an apparatus usually has a number of conveyor apparatus located after one another that have to be alternately started and stopped, which further increases the cost. It has also been found that such an apparatus is relatively slow and that there is a substantial amount of wasted space upon the conveyor apparatus.

### SUMMARY OF THE INVENTION

The invention provides apparatus for nonintrusively inspecting an object, including at least one frame, at least first and second horizontally spaced conveyor belt rollers mounted to said at least one frame, at least a first conveyor belt forming a closed loop that runs over the first and second conveyor belt rollers so that the first conveyor belt, at a particular moment, has forward and return sections, the forward section being capable of supporting the object and conveying the object in a forward direction, an x-ray source mounted to the at least one frame and generating x-rays, including scattered x-rays transmitting in a direction over the forward section of the conveyor belt, and at least one member, of a material that is at least partially resistant to x-rays, mounted to the at least one frame for movement in an orbital return path, a forward portion of which being substantially in the forward direction, during which forward portion the member being in a path of the scattered x-rays transmitting over the forward section of the first conveyor belt.

The apparatus may further include a plurality of x-ray detectors, the x-rays including scanning x-rays that are detected by the detectors.

The apparatus may further include a gantry rotatably secured to the at least one frame, the x-ray source being secured through the gantry.

The scanning x-rays may pass through the forward section of the conveyor belt. The scanning x-rays may pass through the return section of the conveyor belt.

The apparatus may further include a plurality of members, each being of a material that is at least partially resistant to x-rays, each mounted to the at least one frame for movement in the orbital return path such that the respective member is in a path of the scattered x-rays transmitting over the forward section of the first conveyor belt.

One of the members may travel in the forward direction while another one of the members travels in the return direction.

The apparatus may further include a plurality of curtain rollers, and an elongate member forming a closed loop that runs over the curtain rollers so that the elongate member has forward and return portions, the members being curtain members that are attached at spaced intervals on the elongate member.

The curtain members attached to the return portion may overlay one another.

The apparatus may include radiation shielding over the forward section, the object passing through the radiation shielding while being conveyed on the forward section of the conveyor belt.

The invention also provides apparatus for nonintrusively inspecting an object, including at least one frame, at least first and second horizontally spaced conveyor belt rollers mounted to said at least one frame, at least a first conveyor belt forming a closed loop that runs over the first and second conveyor belt rollers so that the first conveyor belt, at a particular moment, has forward and return sections, the forward section being capable of supporting the object and conveying the object in a forward direction, a conveyor motor which, when operated, moves the conveyor belt so that the forward section thereof moves in the forward direction, an x-ray source mounted to the at least one frame and generating x-rays, including scanning x-rays and scattered x-rays, the scattered x-rays transmitting in a direction over the forward section of the conveyor belt, a plurality of x-ray detectors mounted to the at least one frame in a position to detect the scanning x-rays, and at least one member of a material that is at least partially resistant to x-rays, and mounted to the at least one frame for movement in an orbital return path, a forward portion of the orbital path being substantially in the forward direction, during which forward portion the member is in a path of the scattered x-rays transmitting over the forward section of the first conveyor belt.

The invention further provides a method of nonintrusively inspecting an object, including supporting an object on a forward section of a conveyor belt, generating x-rays, including scattered x-rays that transmit in a direction over the forward section of the conveyor belt, positioning a member, of a material that is at least partially resistant to x-rays, in a path of the scattered x-rays transmitting over the forward section of the conveyor belt, moving the forward section of the conveyor belt, with the object thereon, together with the member in a forward direction, and returning the member along an orbital return path to a position that the member occupied before said movement in the forward direction.

The member and the conveyor belt preferably move at the same speed in the forward direction.

### BRIEF DESCRIPTION OF THE DRAWINGS

The invention is further described by way of example with reference to the accompanying drawings, wherein:

FIG. 1 is a cross-sectional side view of apparatus, according to an embodiment of the invention, which is used for nonintrusively inspecting an object;

FIG. 2 is a perspective view of a CT scanner subsystem and a first curtain assembly of the apparatus;

FIG. 3 is a cross-sectional end view on 3-3 in FIG. 1; and

FIG. 4 is a side view of a gear system of the apparatus on 4-4 in FIG. 3.

### DETAILED DESCRIPTION OF THE INVENTION

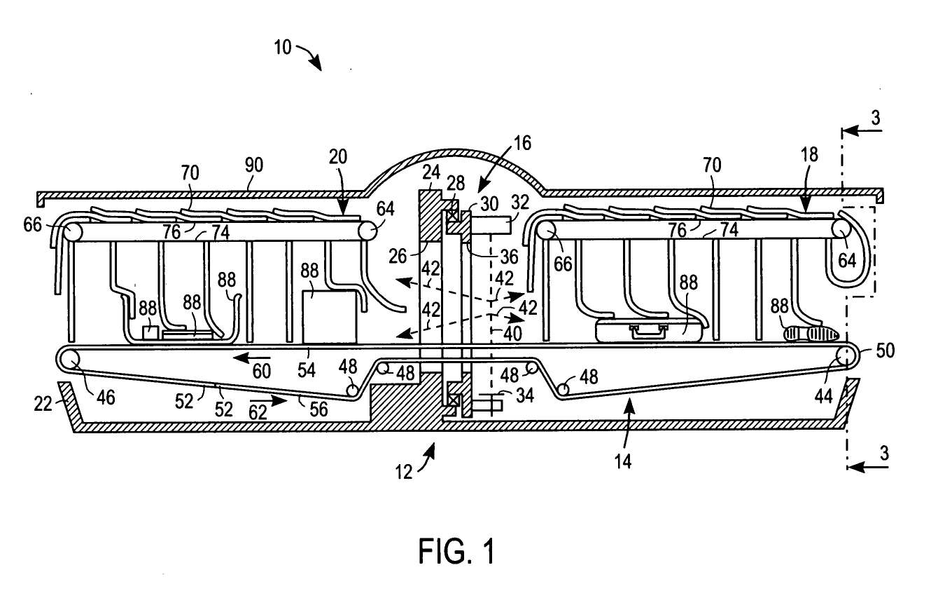

FIG. 1 of the accompanying drawings illustrates apparatus 10, according to an embodiment of the invention, which includes a frame 12, a conveyor system 14, a CT scanner subsystem 16, and first and second curtain subassemblies 18 and 20.

The frame 12 includes a horizontal base structure 22 and a gantry support 24. The base structure is located on a horizontal floor. The support 24 is mounted to the base structure 22 and extends vertically therefrom. A frame opening 26 is defined in the support 24.

The CT scanner subsystem 16 includes a bearing 28, a gantry 30, an x-ray source 32, and a plurality of x-ray detectors 34.

The gantry 30 has a gantry opening 36 formed therein. The gantry 30 is mounted by the bearing 28 to the support 24. Centre lines of the gantry opening 36 and the frame opening 26 are aligned with one another. The gantry 30 rotates on the bearing 28 about the central axis of the gantry opening 36 relative to the support 24.

The x-ray source 32 and the x-ray detectors 34 are mounted to the gantry 30 with the gantry opening 36 between the x-ray source 32 and the x-ray detectors 34. The x-ray source 32 generates and transmits x-rays. The x-rays include scanning x-rays 40 that transmit directly from the x-ray source 32 along a straight line to the x-ray detectors 34. Some of the x-rays are scattered and reflected from various surfaces so that scattered x-rays 42 are created that propagate transversely to the scanning x-rays 40.

The conveyor system 14 includes first and second conveyor belt rollers, 44 and 46 respectively, alignment and tensioning rollers 48, and a conveyor belt 50. The rollers 44, 46, and 48 are all rotatably mounted to the base structure 22. The conveyor belt has ends 52 that are secured to one another so that the conveyor belt forms a closed loop that runs over the first and second conveyor belt rollers 44 and 46. The conveyor belt 50 has forward and return sections, 54 and 56 respectively. The alignment and tensioning rollers 48 are at various positions on the return section 56.

Rotation of the rollers 44, 46, and 48 allows for movement of the forward section 54 in a forward direction 60, while the return section 56 moves in a return direction 62 opposite to the forward direction 60. The forward section 54 at the top eventually becomes the return section 56 at the bottom and the return section 56 becomes the forward section 54, but the conveyor belt 50 always has one forward section at the top and one return section at the bottom.

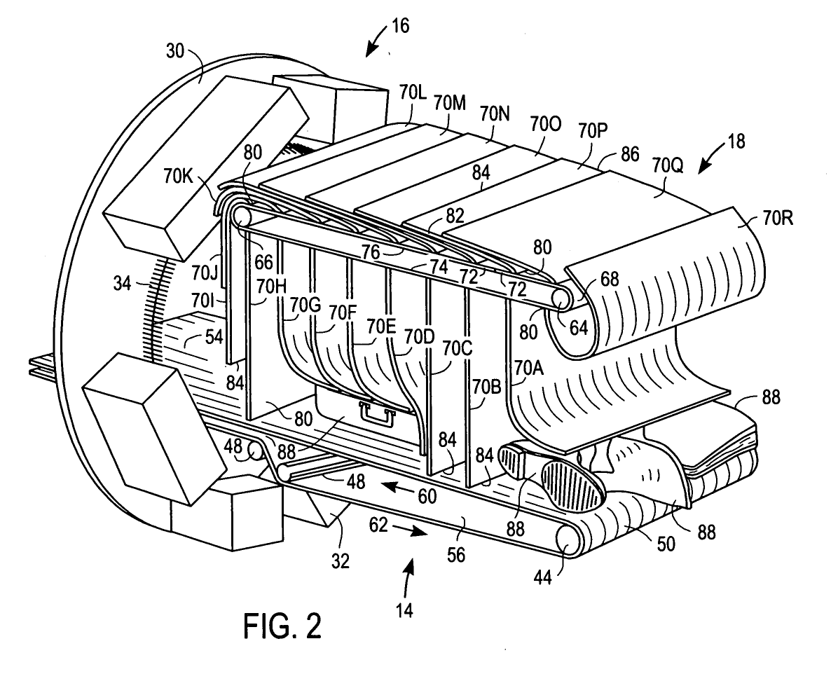

Referring now to FIG. 2 in combination with FIG. 1, the first curtain subassembly 18 includes first and second curtain rollers, 64 and 66 respectively, a flexible member 68, and a plurality of curtain members 70.

The first and second curtain rollers 64 and 66 are mounted to portions of the frame 12. Each curtain roller 64 and 66 is mounted above and in vertically spaced positions from the forward section 54 of the conveyor belt 50. The curtain rollers 64 and 66 have central axes that are parallel to a central axis of the first conveyor belt roller 44. The first and second curtain rollers 64 and 66 are horizontally spaced from one another in a direction that the forward section 54 of the conveyor belt 50 moves.

The flexible member 68 is typically a chain and has opposing ends 72 that are secured to one another to form a closed loop, in which case the first and second curtain rollers 64 and 66 are pulleys or chain gears. Alternatively, the flexible member 68 may be a conveyor belt, and the first and second curtain rollers 64 and 66 may be conveyor belt rollers. The flexible member 68 runs over the first and second curtain rollers 64 and 66. The flexible member 68 has a forward portion 74 at the bottom and a return portion 76 at the top. Rotation of the curtain rollers 64 and 66 causes movement of the forward portion 74 in the same forward direction 60 as the forward section 54 of the conveyor belt 50. The return portion 76 simultaneously moves in the return direction 62 of the return section 56 of the conveyor belt 50. The forward portion 74 at the bottom eventually becomes the return portion 76 at the top, and the return portion 76 becomes the forward portion 74. At any particular moment in time, the flexible member 68 has a forward portion at the bottom and a return portion at the top.

The curtain members 70 are all made of a material that is at least resistant to x-ray radiation, and preferably of a material such as lead that attenuates x-ray radiation. Each curtain member, e.g., the curtain member 70P, has four sides, 80, 82, 84 and 86 respectively. One of the sides 80 is secured to the flexible member 68. The opposing sides 80 and 84 both extend parallel to an axis of, for example, the first curtain roller 64. The opposing sides 82 and 86 extend at right angles to the axis of the first curtain roller.

The curtain members 70 are all secured in the same manner at spaced locations along the forward and return portions, 74 and 76 respectively, of the flexible member 68. The curtain members 70A to 70H are secured to and hang from the forward portion 74. The curtain members 70I to 70Q are secured to the return portion 76 and overlay one another. Some of the curtain members 70I to 70K that are secured to the return portion 76 are still draped over the second curtain roller 66. A further curtain member 70R is secured to the forward portion 74, but is still wrapped around the first curtain roller 64 and partially overlays the curtain member 70Q.

In use, the rollers 44, 46, and 48 of the conveyor system 14 rotate counter-clockwise to cause movement of the forward section 54 of the conveyor belt 50 at a constant speed in the forward direction 60. Objects 88 are placed on the forward section 54 and are conveyed from right to left on the conveyor belt 50.

The first and second curtain rollers 64 and 66 rotate clockwise to cause movement of the forward portion 74 of the flexible member 68 in the forward direction 60. The forward portion 74 of the flexible member 68 moves at exactly the same speed as the forward section 54 of the conveyor belt 50. The curtain members 70A to 70H that are suspended from the forward portion 74 thus remain stationary relative to the objects 88 and the forward section 54 while moving in the forward direction 60 relative to the frame 12. By moving the curtain members 70A to 70H in unison with the objects 88, the objects 88 do not have to move the curtains out of the way like in conventional systems where stationary curtains are used. The curtain members 70A to 70H thus do not hinder the passing of small or lightweight objects.

After movement of a particular curtain member 70 from the first curtain roller 64 to the second curtain roller 66, the respective curtain member, e.g., the curtain member 70I, begins to fold. The side 80 of the folding curtain member 70I begins to return toward the first curtain roller 64 and the side 84 of the folding curtain member 70I begins to lift off the forward section 54 of the conveyor belt 50. The folded curtain members 70I to 70Q then overlay one another, with the side 84 of a respective curtain member 70I to 70Q trailing the side 80 thereof. When a curtain member, e.g., the curtain member 70R, reaches the first curtain roller 64 and the side 80 thereof rolls over the first curtain roller 64, the curtain member 70R falls down and onto the forward section of the conveyor belt 50 or an object 88 supported on the forward section 54.

The curtain members 70A to 70H combine to prevent the scattered x-rays 42 from leaving the apparatus over the forward section 54 of the conveyor belt 50. The objects 88 are spaced from one another so that at least one of the curtain members, e.g., 70B, 70C, and 70H, is located between the objects 88 with its side 84 adjacent to the forward section 54 of the conveyor belt 50.

The forward section 54 of the conveyor belt 50 passes through the gantry opening 36 and the frame opening 26 so that the objects 88 are transported through the gantry opening 36 of the frame opening 26. The gantry 30 may rotate at a constant speed. The x-ray source 32 generates x-rays that transmit through the object 88 and through the conveyor belt 50 and are detected by the x-ray detectors 34. By simultaneously rotating the CT scanner subsystem 16 and detecting the x-rays with the x-ray detectors 34, each object 88 can be inspected from different sides. As mentioned, the first curtain subassembly 18 does not require that the conveyor belt 50 be stopped, so that the x-ray source 32 effectively rotates as a spiral about the respective object, and thus continuously scans the object. It is believed that continuous scanning can lead to a less expensive machine as a whole, less space wasted on a conveyor belt, and faster throughput. The conveyor belt 50 can still be stopped together with the first curtain assembly 18, depending on factors such as a particular type of scan that has to be carried out, etc.

It may also be required to occasionally stop the forward motion of the system, such as when an object such as a carry-on item becomes stuck therein. Panels on the side of the system can then be opened to remove the carry-on item. The system can then again be started and resume its forward motion.

After leaving the CT scanner subsystem 16, the object passes through the second curtain subassembly 20. The second curtain subassembly 20 is identical to the first curtain subassembly 18. The only difference between the curtain subassemblies 18 and 20 is that the first curtain subassembly 18 prevents the scattered x-rays 42 from leaving to the right out of the apparatus 10, while the second curtain subassembly 20 prevents the scattered x-rays 42 from leaving to the left out of the apparatus 10.

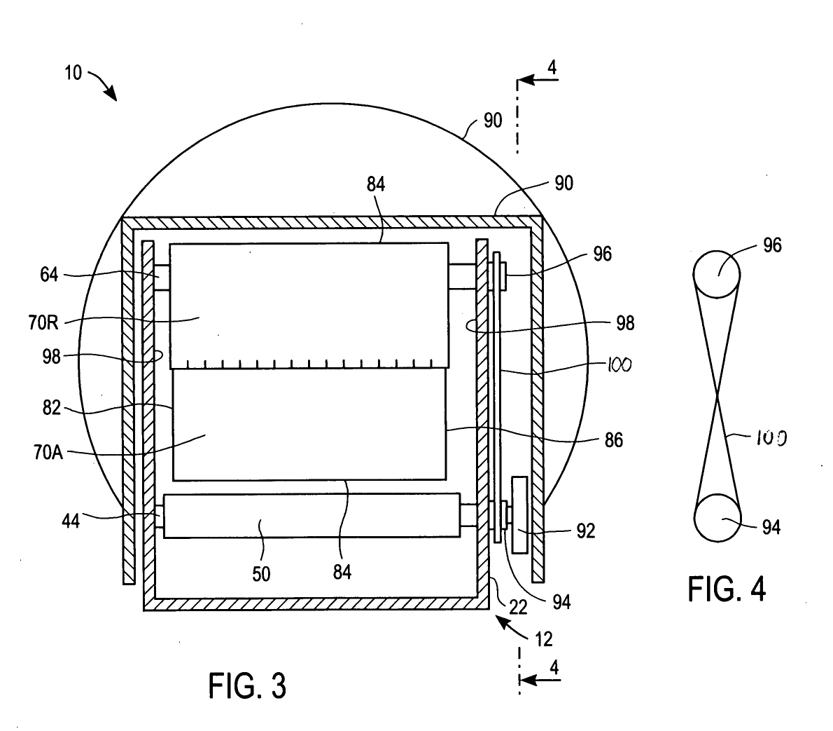

Referring now to FIGS. 1 and 3 in combination, the apparatus 10 further includes x-ray shielding panels 90, a motor 92, a first gear 94, a second gear 96, and a gear chain 100.

The x-ray shielding panels 90 are located around the components hereinbefore described. As more particularly shown in FIG. 3, the x-ray shielding panels 90 are located to the left, the right, and above an object located on the conveyor belt 50. The x-ray shielding panels 90 thus prevent scattered x-rays from leaving to the left, the right, or the top. One of the x-ray shielding panels is a door that can be opened for purposes of maintenance or for releasing jammed objects.

The curtain members 70 prevent the x-rays from leaving in a direction out of the paper. Although not shown, it is to be understood that the curtain members 70 rub very closely against other components of the frame 12 and/or the panels 90, and further prevent x-rays from leaving out of the system 10.

With further reference to FIG. 3, the first conveyor belt roller 44, as with all the rollers 44, 46, and 48 of the conveyor system 14, has opposing ends that are rotatably mounted to the opposing portions of the base structure 22. The frame 12 further has opposing portions 98 extending upward from the base structure 22. The first curtain roller 64, as with the curtain rollers 64 and 66 of both curtain subassemblies 18 and 20, have opposing ends rotatably secured to the opposing portions 98.

The first conveyor belt roller 44 and the first gear 94 are both connected to the motor 92. When the motor 92 is operated, the first gear 94 and the first conveyor belt roller 44 rotate in unison. The second gear 96 is connected to the curtain roller 64, so that the second gear 96 and the second curtain roller 64 rotate in unison. The gear chain 100 runs over the first and second gears 94 and 96. Rotation of the first gear 94 causes rotation of the second gear 96. The second gear 96 and the curtain roller 64 are rotated by the motor 92. Operation of the motor 92 thus causes simultaneous rotation of the first conveyor belt roller 44 and the curtain roller 64. Referring to FIG. 4, the gear chain 100 may cross over itself so that the gears 94 and 96 rotate in opposite directions.

In another embodiment, two motors may be used to drive the first conveyor belt roller 44 and the first curtain roller 64. A control system may be connected to both motors, and control the motors so as to rotate the rollers 44 and 64 in unison.

It can thus be seen that each curtain member 70 follows and repeats an orbital return path. In the present example, two portions of the orbital path, corresponding respectively to the forward and return portions of the flexible member 68, are straight. The benefit of a straight portion of the orbital path is that the straight portion of the orbital path can run parallel with the forward section 54 of the conveyor belt for an extended period of time, and the curtain members 70 can, accordingly, move together with the conveyor belt 54 for almost the entire length of the straight portion of the orbital path. In another example, the orbital path may be entirely circular or elliptical without departing from the general scope of the invention.

In the present example, the curtain members 70 are mounted via the flexible member 68 and the first and second curtain rollers 64 and 66 to the frame 12. In another example, radiation-shielding members may be mounted via the conveyor belt 50 and the first and second conveyor belt rollers 44 and 46 to the frame 12.

In the present example, a single conveyor belt 50 is used, which is mounted to a single frame 12. In another embodiment, the first curtain subassembly 18 and the CT scanner subsystem 16 may be mounted to separate frames, each having a respective conveyor system mounted thereto. It may also be possible that two or more x-ray sources may be provided that are mounted to the same or different frames.

In the present example, a conveyor belt 50 is provided to transport the objects 88 in the forward direction 60. One skilled in the art will appreciate that it may be possible to replace the conveyor belt 50 with another system to convey the objects 88 in the forward direction. One such alternative system includes an array of rollers, also referred to as a “roller bed,” and is useful particularly because of its ability to transport a relatively large number of objects at a relatively fast throughput rate.

In the foregoing description, an example is given of apparatus and a method for inspecting closed containers before being loaded into a loading bay of an airplane. Such use may, for example, be for the detection of explosives within closed containers. It should, however, be understood that the invention is not to be limited to the inspection of a closed container before being loaded into a loading bay of an airplane. Various aspects of the invention may, for example, find application in the detection of contraband and illicit materials generally, applications beyond those linked to aviation, such as rail travel, the inspection of mail or parcels, non-destructive testing, inspection for defects such as cracks in fabricated metal objects, and materials testing and characterization.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. An apparatus for nonintrusively inspecting an object, comprising:
at least one frame;
at least first and second horizontally spaced conveyor belt rollers mounted to said at least one frame;
at least a first conveyor belt forming a closed loop that runs over the first and second conveyor belt rollers so that the first conveyor belt, at a particular moment, has forward and return sections, the forward section being capable of supporting the object and conveying the object in a forward direction;
an x-ray source mounted to the at least one frame and generating x-rays, including scattered x-rays transmitting in a direction over the forward section of the conveyor belt; and
at least one member, of a material that is at least partially resistant to x-rays, mounted to the at least one frame for movement in an orbital return path, a forward portion of which being substantially in the forward direction, during which forward portion the member is in a path of the scattered x-rays transmitting over the forward section of the first conveyor belt.

2. The apparatus of claim 1, further comprising a plurality of x-ray detectors, the x-rays including scanning x-rays that are detected by the detector.

3. The apparatus of claim 1, further comprising a gantry rotatably secured to the at least one frame, the x-ray source being secured through the gantry.

4. The apparatus of claim 1, wherein the scanning x-rays pass through the forward section of the conveyor belt.

5. The apparatus of claim 1, wherein the scanning x-rays pass through the return section of the conveyor belt.

6. The apparatus of claim 1, further comprising a plurality of members, each being of a material that is at least partially resistant to x-rays, each mounted to the at least one frame for movement in the orbital return path such that the respective member is in a path of the scattered x-rays transmitting over the forward section of the first conveyor belt.

7. The apparatus of claim 6, wherein one of the members travels in the forward direction while one of the members travels in the return direction.

8. The apparatus of claim 7, further comprising a plurality of curtain rollers, and an elongate member forming a closed loop that runs over the curtain rollers so that the elongate member has forward and return portions, the members being curtain members that are attached at spaced intervals on the elongate member.

9. The apparatus of claim 8, wherein the curtains attached to the return portion overlay one another.

10. The apparatus of claim 1, further comprising radiation shielding over the forward section, the object passing through the radiation shielding while being conveyed on the forward section of the conveyor belt.

11. An apparatus for nonintrusively inspecting an object, comprising:
at least one frame;
at least first and second horizontally spaced conveyor belt rollers mounted to the said at least one frame;
at least a first conveyor belt forming a closed loop that runs over the first and second conveyor belt rollers so that the first conveyor belt, at a particular moment, has forward and return sections, the forward section being capable of supporting the object and conveying the object in a forward direction;
a conveyor motor which, when operated, moves the conveyor belt so that the forward section thereof moves in the forward direction;
an x-ray source mounted to the at least one frame and generating x-rays, including scanning x-rays and scattered x-rays, the scattered x-rays transmitting in a direction over the forward section of the conveyor belt;
a plurality of x-ray detectors mounted to the at least frame in a position to detect the scanning x-rays; and
at least one member of a material that is at least partially resistant to x-rays, and mounted to the at least one frame for movement in an orbital return path, a forward portion of the orbital path being substantially in the forward direction, during which forward portion the member is in a path of the scattered x-rays transmitting over the forward section of the first conveyor belt

12. A method of nonintrusively inspecting an object, comprising;
supporting an object on a forward section of a conveyor belt;
generating x-rays, including scattered x-rays that transmit in a direction over the forward section of the conveyor belt;
positioning a member, of a material that is at least partially resistant to x-rays, in a path of the scattered x-rays transmitting over the forward section of the conveyor belt;
moving the forward section of the conveyor belt, with the object thereon, together with the member in a forward direction; and
returning the member along an orbital return path to a position that the member occupied before said movement in the forward direction.

13. The method of claim 12, wherein the member and the conveyor belt move at the same speed in the forward direction.

14. An apparatus for nonintrusively inspecting an object, comprising:
means for supporting the object and conveying the object in a forward direction;
an x-ray source generating x-rays, including scanning x-rays and scattered x-rays;
means for detecting the scanning x-rays; and
at least one member, of a material that is at least partially resistant to x-rays, mounted for movement in an orbital return path, a forward portion of which being substantially in the forward direction, during which forward portion the member is in a path of the scattered x-rays.

15. The apparatus of claim 14, further comprising a plurality of members, each being of a material that is at least partially resistant to x-rays, each mounted for movement in the orbital return path such that the respective member is in a path of the scattered x-rays.

16. The apparatus of claim 15, wherein one of the members travels in the forward direction while one of the members travels in the return direction.
